(19) United States
(12) Patent Application Publication
(10) Pub. No.: US 2024/0375198 A1
(43) Pub. Date: Nov. 14, 2024

(54) MACHINE TOOL WITH CALIBRATION DEVICE FOR CALIBRATING A MESHING SENSOR

(71) Applicant: Reishauer AG, Wallisellen (CH)

(72) Inventors: Erwin SENNHAUSER, Kleinandelfingen (CH); Hartmut MARX, Wallisellen (CH); Franz BACHL, Wallisellen (CH); Lorenz WINKLER, Winterthur (CH)

(73) Assignee: Reishauer AG, Wallisellen (CH)

(21) Appl. No.: 18/690,509

(22) PCT Filed: Aug. 26, 2022
(86) PCT No.: PCT/EP2022/073814

§ 371 Date: Mar. 8, 2024

(30) Foreign Application Priority Data
Sep. 10, 2021 (CH) CH070259/2021

(51) Int. Cl. B23F 23/10; B23F 1/06

(52) U.S. Cl. CPC B23F 23/10; B23F 1/06

(57) ABSTRACT

A machine tool for machining pre-toothed workpieces has a workpiece carrier, a workpiece spindle with a workpiece spindle housing and a workpiece spindle shaft. The machine tool has a meshing sensor, a calibration piece, and a sensor controller which is designed to perform the following procedure: Moving the meshing sensor relative to the workpiece spindle into a calibration position in which the meshing sensor is located at the calibration piece 10; determining a response behavior of the meshing sensor by the sensor controller moving the meshing sensor relative to the calibration piece and meanwhile receiving sensor calibration signals of the meshing sensor, and moving the meshing sensor into a workpiece measuring position in which the meshing sensor is located at the workpiece, the workpiece measuring position depending on the determined response behavior.

### TECHNICAL FIELD

The present invention relates to a machine tool for machining pre-toothed workpieces, which has a calibration device configured to calibrate a meshing sensor of the machine tool.

### PRIOR ART

When precision machining pre-toothed workpieces, the tool and the workpiece to be machined must be aligned with each other before the start of each machining operation in such a way that the tool can enter the tooth gap of the workpiece without collision. This procedure is known in the art as “meshing”.

Such meshing is required in particular for continuously operating rolling machining processes. In such processes, the workpiece to be machined is brought into engagement with a worm-shaped tool and machined in rolling coupling with the tool. In modern, numerically controlled (NC-controlled) gear cutting machines, the workpiece is clamped on an NC-controlled, rotary-driven workpiece spindle for this purpose. The tool is clamped on a likewise NC-controlled, rotationally driven tool spindle. The rolling coupling between the tool spindle and the workpiece spindle is then established electronically by the NC control. For processes other than rolling machining, e.g. profile grinding, precise knowledge of the position of the tooth gaps of the workpiece to be machined is also required.

Usually, contactless meshing sensors are used for meshing, which work on an inductive or capacitive basis and determine the position of the tooth flanks while the workpiece is rotating. The rolling coupling angle is determined electronically on the basis of such a non-contact measurement.

Such a contactless meshing method is known, for example, from DE 36 15 365 C1. In this method, the workpiece to be machined is set in rotation and the phase position of signals is determined which are generated when the teeth of the workpiece move past a fixed meshing sensor. This phase position is compared with the phase position determined in a reference measurement with a gear of known orientation. The rolling coupling angle between the workpiece and the tool is set according to the difference between these phase positions.

Other checks can also be carried out on the basis of the phase position of the signals of all teeth over a workpiece rotation. For example, a check can be made for pre-machining errors and concentricity deviations, and the tooth gap width can be used to estimate the existing grinding allowance.

The phase position determined by the meshing sensor generally depends on the position of the meshing sensor relative to the workpiece. If, for example, the position of the meshing sensor relative to the gear changes in the tangential direction, relative to the axis of rotation of the gear, between the reference measurement and the measurement on a workpiece to be machined, the phase position determined no longer corresponds to the actual position of the teeth. This results in more material than desired being removed from the right-hand tooth flanks and less material than desired being removed from the left-hand tooth flanks during subsequent machining, or vice versa. In extreme cases, no material is removed at all from some of the tooth flanks. In the case of helical gears, the phase position determined also depends on the axial position of the meshing sensor along the axis of rotation of the gear. Deviations with regard to the radial position of the meshing sensor relative to the axis of rotation can lead to the tooth gap width or the existing grinding allowance being over- or underestimated.

For a meshing sensor to function properly, it is therefore important that the spatial position of the meshing sensor relative to the workpiece spindle is always the same from measurement to measurement. However, this is not always easy to ensure. For example, the position of the meshing sensor can change during operation of the gear cutting machine due to thermal expansion. This is particularly true if the meshing is not mounted in the immediate vicinity of the workpiece spindle on the machine due to the machine design. Reproducible positioning of the meshing sensor becomes particularly challenging when the meshing sensor is movable relative to the workpiece spindle. For example, the meshing sensor can be located on a tool carrier of the machine and can be movable together with the tool relative to the workpiece spindle. It is therefore desirable to be able to determine the exact spatial position of the meshing sensor relative to the workpiece spindle in order to be able to position the meshing sensor reproducibly relative to the workpiece spindle.

In addition, meshing sensors often have to be replaced, e.g. to replace a defective meshing sensor. However, the meshing sensors do not always have exactly the same response behavior. For example, if the meshing sensor is a meshing sensor having a switching region, wherein a presence of material within the switching region is indicated by a change in the output signal output from the meshing sensor, the exact shape and location of the switching region with respect to a meshing sensor surface may vary from meshing sensor to meshing sensor. It is therefore desirable to be able to determine the response behavior of the meshing sensor in order to calibrate the meshing sensor and accordingly take the response behavior into account when positioning the meshing sensor relative to the workpiece spindle.

In DE102019104812A1, a tactile sensor or a non-contact measuring element is used to determine the effective grinding allowance on tooth or profile flanks. In addition, the use of an inductive meshing sensor that outputs switching signals is proposed in order to realize a further optimized process sequence in combination of the meshing sensor with the tactile sensor or the non-contact measuring element. The positioning of the tactile sensor or the contactless measuring element is preferably carried out via a linear axis of the grinding machine. The document discloses that after calibration of the tactile sensor by means of a reference body of known geometry (e.g. ball of known diameter), the tactile sensor can be moved specifically to the required position by means of the linear axis. The measured values of the tactile sensor or the non-contact measuring element are recorded by the machine controller and processed in a manner known per se in order to find the optimum center position of the workpiece relative to the grinding tool with respect to the toothing or profiling. However, calibration of the inductive, switching meshing sensor is not mentioned in this document.

### SUMMARY OF THE INVENTION

It is therefore an object of the present invention to provide a machine tool for machining pre-toothed workpieces having a calibration device suitable for calibrating the spatial position of a meshing sensor used in the machine tool.

This object is solved by a machine tool with the features of claim 1. Further embodiments are given in the dependent claims.

Thus, a machine tool for machining pre-toothed workpieces is provided. This comprises:
a workpiece carrier;
a workpiece spindle arranged on the workpiece carrier and defining a workpiece spindle axis, the workpiece spindle having a workpiece spindle housing and a workpiece spindle shaft rotatable in the workpiece spindle housing about the workpiece spindle axis for rotationally driving a pre-toothed workpiece to be machined, and
a meshing sensor configured to detect a phase position of teeth of the workpiece when the workpiece rotates about the workpiece spindle axis.

The machine tool further comprises a calibration piece located at a defined calibration point relative to the workpiece spindle, and a sensor controller configured to perform the following method:
moving the meshing sensor relative to the workpiece spindle to a calibration position in which the meshing sensor is located at the calibration piece;
determining a response behaviour of the meshing sensor by having the sensor controller move the meshing sensor relative to the calibration piece while receiving sensor calibration signals from the meshing sensor, and
moving the meshing sensor to a workpiece measuring position in which the meshing sensor is located at the workpiece, wherein the workpiece measuring position depends on the determined response behavior.

Moving the meshing sensor relative to the calibration piece may include movements in an axial direction and/or in a radial direction and/or in a tangential direction with respect to the workpiece spindle.

Depending on the arrangement in the machine tool, the calibration piece may have different shapes and structures. All embodiments of the calibration piece of the present invention have in common that they enable a determination of the response behavior of the sensor. If the meshing sensor is moved along the calibration piece during the method for calibration, for example in a tangential or axial or radial direction with respect to the workpiece spindle, the calibration piece preferably has at least one structure along said direction, such as an edge or a step, which can be detected as a change in an output signal of the meshing sensor.

For optimum calibration, the sensor is moved during the calibration method in all those directions along the calibration piece in which the meshing sensor can be moved.

Several possibilities for arranging the calibration piece in the machine tool are conceivable. Preferably, the calibration piece is arranged in the machine tool in such a way that the meshing sensor can be moved from the calibration position to the workpiece measuring position (and vice versa) without collision, even if a machining tool is already clamped in the machine tool.

The calibration piece may be arranged on the workpiece carrier, for example. The workpiece carrier may be a movable slide on which the workpiece spindle is located. The calibration piece can then be moved together with the workpiece carrier and is always in a defined position relative to the workpiece carrier. Preferably, the calibration piece is arranged in such a way that it is not in the way of a gripper arm optionally used for clamping a machining tool and/or a workpiece.

In particular, the calibration piece may be arranged on a stationary part of the workpiece spindle, especially on the workpiece spindle housing.

Instead, however, the calibration piece may also be arranged on a rotatable part of the workpiece spindle.

By arranging the calibration piece on a stationary or rotatable part of the workpiece spindle, the advantage is that the calibration piece is located close to the workpiece to be machined, which reduces any calibration inaccuracies.

The workpiece spindle may have a clamping means for clamping a workpiece on the workpiece spindle shaft. In such a case, the calibration piece can be arranged on the clamping means. The calibration piece may be designed in such a way that it can be detachably fastened to the clamping means.

The calibration piece may further be configured in such a way that it can be attached to the clamping device and removed from the clamping device by an automatic workpiece loading device.

Particularly suitable for being fastened to the clamping means are preferably disc-shaped calibration pieces which have an outer profile with at least one tooth structure, for example a calibration tooth or a calibration tooth gap. For example, the calibration piece may be a reference workpiece that can be clamped onto the workpiece spindle. The calibration piece may also be a workpiece to be machined or a freshly machined workpiece.

An arrangement in which the calibration piece is clamped on the workpiece spindle minimizes the distance between the workpiece measuring position and the calibration position, which means that the meshing sensor only has to be moved a short distance for calibration, allowing the use of precise positioning mechanisms. On the other hand, the calibration piece must be inserted into the clamping means before the workpiece is machined and removed again after the calibration of the meshing sensor, which is more time-consuming than calibration with a calibration piece that is permanently installed (for example on the tool carrier or on a fixed part of the tool spindle). In addition, it may be necessary to first determine an angular position of the calibration piece around the workpiece spindle axis before the meshing sensor can be calibrated. If the calibration piece is the workpiece to be machined, the additional time required for inserting and removing a separate calibration piece is eliminated, but even in such a case, at least the angular position of the workpiece must usually first be determined using an additional measurement.

To determine the position of the calibration piece and/or to measure it, the machine tool may have a tactile sensor. Said tactile sensor may be configured in particular to determine a position of at least one tooth structure of a disk-shaped calibration piece, for example a workpiece.

The calibration piece may, for example, have a substantially cuboid base body.

The base body of the calibration piece may have a first groove with a preferably rectangular or trapezoidal cross-section. This means that the calibration piece has different edges which extend in different spatial directions, which is well suited for non-contact scanning of the calibration piece with the meshing sensor for the purpose of determining the response behavior.

Preferably, the calibration piece is arranged in the machine tool in such a way that the first groove in the base body of the calibration piece runs perpendicular to the workpiece spindle axis.

The base body of the calibration piece may also have a second groove with a preferably rectangular or trapezoidal cross-section, which runs at an angle, in particular perpendicular, to the first groove and opens into the first groove. This second groove forms an indentation which imitates the shape of a tooth gap on the workpiece and is therefore a particularly suitable shape for calibrating the meshing sensor.

If the calibration piece has a second groove as described above, through which a tooth gap-like indentation is formed, it is advantageous to arrange the calibration piece in the machine tool in such a way that the second groove in the base body of the calibration piece runs parallel to the workpiece spindle axis, whereby the tooth gap-like indentation of the calibration piece has a similar orientation in the coordinate system of the machine tool as the tooth gaps of a straight-toothed workpiece.

The calibration piece may have a cuboid projection which extends radially from a surface of a portion of the workpiece spindle, wherein the cuboid projection is flanked by two orientation areas, and wherein the flanking orientation areas are arranged on both sides of the projection with respect to a tangential direction. The response of the meshing sensor is preferably determined on the basis of the cuboid protrusion in such a calibration piece. The orientation areas can be used to align the workpiece spindle with respect to a reference area in the machine tool in order to obtain a defined orientation of the calibration piece.

Alternatively, the calibration piece may have a cylindrical base body, the cylindrical base body having a cylinder axis which preferably runs perpendicular to the workpiece spindle axis. A calibration piece with such a cylindrical base body is particularly advantageous if helical-toothed workpieces are machined in the machine tool, since in such a case the meshing sensor can be moved relative to the calibration piece in a direction normal to a tooth flank of the helical-toothed workpiece in order to determine the response behavior.

As a further alternative, the calibration piece may also have a spherical base body or a dome-shaped base body. Spherical or dome-shaped base bodies can be particularly suitable for simulating pressure angles and helix angles of the workpiece to be machined.

The machine tool may have a tool carrier on which a tool spindle is arranged for rotationally driving a machining tool, with the meshing sensor being arranged on the tool carrier.

The sensor controller may be an integral part of a machine control. It may be configured to cause the movement of the meshing sensor relative to the workpiece spindle by movements of the tool carrier relative to the workpiece spindle.

The machine tool may further comprise a sensor positioning device for positioning the meshing sensor, which is arranged on the tool carrier and is movable together with the tool carrier relative to the workpiece spindle, wherein the sensor positioning device is configured to move the meshing sensor relative to the tool carrier, and wherein the sensor controller is configured to effect the movement of the meshing sensor relative to the workpiece spindle by movements of the tool carrier relative to the workpiece spindle and/or by movements of the sensor positioning device relative to the tool carrier.

The sensor positioning device may also have a sensor positioning arm that is movable, in particular linearly displaceable, relative to the tool carrier.

Additionally, the sensor positioning device may include a sensor holder for receiving a sensor carrier, wherein the sensor carrier includes a stop element, wherein the meshing sensor includes a meshing sensor surface, and wherein the meshing sensor is mounted in the sensor carrier such that the meshing sensor surface is at a defined distance from the stop element.

Such a sensor carrier forms a uniform interface to the sensor holder for meshing sensors of different sizes. If the meshing sensor needs to be replaced, it can be removed from the sensor holder together with the sensor carrier. A new meshing sensor is then installed in the sensor carrier in such a way that its meshing sensor surface is also at the same defined distance from the stop element, which can be checked by a suitable measuring device before the sensor carrier is reinstalled in the sensor holder.

The meshing sensor is preferably a contactless inductive or capacitive sensor. However, meshing sensors based on optical measuring principles are also conceivable. If an inductive sensor is used, the calibration piece preferably consists of an electrically conductive material, in particular steel or aluminum, and/or has an electrically conductive surface. If, on the other hand, a capacitive sensor is used, the calibration piece preferably consists of a dielectric material and/or has a surface made of a dielectric material.

The meshing sensor may be configured to output a switching signal, wherein the meshing sensor has a sensor-specific switching region, and wherein the sensor-specific switching region defines a fictitious sensor axis. If material enters the switching region, the switching signal changes. The switching signal may be analog or digital. In particular, the switching signal may be a binary switching signal that indicates whether material is present within the switching region: If yes, the binary switching signal assumes a first value, preferably a logical one, if no, the binary switching signal assumes a second value, preferably a logical zero.

The calibration point of the calibration piece is preferably known in a coordinate system of the workpiece carrier. The sensor controller is preferably configured to determine the position of the fictitious sensor axis by determining the response behavior of the meshing sensor on the calibration piece.

In a first step, a peak switching point of the switching region of the meshing sensor may be determined by moving the meshing sensor in the normal direction towards an end face of the calibration piece, the end face preferably being arranged parallel to the workpiece spindle axis. If a theoretical position of the meshing sensor in the coordinate system of the workpiece carrier is already known, for example because it has been determined by a geometric measurement in the machine and stored in the sensor controller, the determination of the peak switching point can also be omitted, since the known theoretical position of the meshing sensor allows the latter to be moved directly to a predefined calibration position. However, the meshing sensor can also be in an instantaneous position that deviates from the theoretical position; for example, if the machine is in a different temperature state than during the determination of the theoretical position. Likewise, the instantaneous position of the meshing sensor can deviate from the theoretical position if there is an installation error of the meshing sensor. Such an installation error can be detected by determining the peak switching point in the coordinate system of the workpiece carrier.

If the peak switching point is known (by explicit determination or from a deposit in the sensor controller), the meshing sensor can be positioned in such a way that a meshing sensor surface of the meshing sensor is radially spaced from the end face of the calibration piece by a first measuring distance. Preferably, this first measuring distance corresponds to a predefined measuring distance which should also occur between the meshing sensor surface and a tip circle of the workpiece when the meshing sensor is in the workpiece measuring position. Now, the meshing sensor can be moved axially and/or tangentially relative to the calibration piece to scan the calibration piece without contact. Meanwhile, the meshing sensor preferably outputs sensor calibration signals from which flank switching points can be determined that are located on a switching interface delimiting the switching region. From these flank switching points, a central point can then be determined through which a fictitious sensor axis can be placed, whereby the fictitious sensor axis is preferably placed perpendicular to the workpiece spindle axis and normal to the face of the calibration piece through the central point.

Alternatively, flank switching points can also be determined at a further measuring distance, whereby further central points can be determined through which a further fictitious sensor axis can be laid. It is also conceivable that flank switching points are determined at more than two measuring distances so that the entire switching interface can be virtually reconstructed as such.

The sensor controller is preferably further configured to calculate the workpiece measuring position from the known calibration point of the calibration piece, a predefined measuring axis and the determined fictitious sensor axis in such a way that the determined fictitious sensor axis coincides with the predefined measuring axis, wherein preferably one of the determined central points lies on an intersection point of the measuring axis with the tip circle of the workpiece when the meshing sensor is in the calculated workpiece measuring position.

The fact that the determined fictitious sensor axis comes to lie on the measuring axis ensures that the phase position subsequently measured on the workpiece ideally depends only on the properties of the workpiece to be machined and is not falsified by an unwanted offset of the fictitious sensor axis of the meshing sensor with respect to the measuring axis.

The calibration point of the calibration piece and the predefined measurement axis may be stored in a memory of the sensor controller, which allows the method to be carried out automatically.

The coordinate system of the workpiece carrier may be a Cartesian coordinate system with an X, a Y and a Z direction. Alternatively, the coordinate system of the workpiece carrier may be a spherical or cylindrical coordinate system, or another coordinate system that enables the position of a point in space to be represented unambiguously.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1a, 1b show in perspective view an embodiment of a machine tool for machining pre-toothed workpieces according to the present invention;

FIG. 2a-2d show in perspective view five different embodiments of a calibration piece according to the present invention;

FIG. 2e shows in perspective view a machine tool according to the present invention with a sixth embodiment of the calibration piece;

FIG. 2f shows an enlarged perspective view of the sixth embodiment of the calibration piece of FIG. 2e;

FIG. 2g shows a side view of a machine tool according to the present invention with a seventh embodiment of the calibration piece;

FIG. 2h shows in an enlarged side view the seventh embodiment of the calibration piece of FIG. 2g;

FIG. 3a, 3b show a preferred arrangement of a calibration piece in a machine tool according to the present invention;

FIG. 3c shows a sensor holder for holding the meshing sensor;

FIG. 4a-4d show in a schematic (not to scale) manner, a method for calibrating a meshing sensor according to the present invention;

FIG. 5 shows a flowchart illustrating a method according to one embodiment of the present invention.

### DESCRIPTION OF PREFERRED EMBODIMENTS

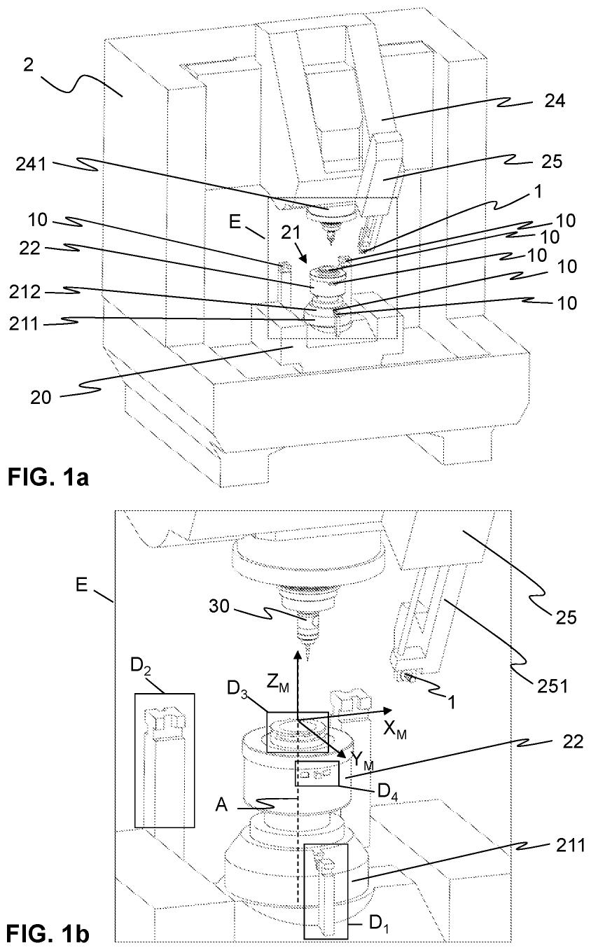

FIGS. 1a and 1b show a perspective view of an embodiment of a machine tool 2 for machining pre-toothed workpieces, with FIG. 1b showing an enlargement of the section E framed in FIG. 1a. In particular, the embodiment shown here is a machine tool for the rolling machining of rotary parts with groove-shaped profiles. Such a machine tool is described in document WO2021008915A1, the disclosure of which is incorporated herein by reference in its entirety. The machine tool 2 has a workpiece carrier 20, a workpiece spindle 21 arranged on the workpiece carrier 20 and defining a workpiece spindle axis A, the workpiece spindle 21 having a workpiece spindle housing 211 and a workpiece spindle shaft 212 rotatable in the workpiece spindle housing 211 about the workpiece spindle axis A for rotationally driving a pre-toothed workpiece to be machined, and a clamping means 22, the clamping means 22 being configured to receive a workpiece to be machined. A Cartesian coordinate system K_{M} referenced to the workpiece carrier 20 with an X_{M} direction, a Y_{M} direction and a Z_{M} direction is drawn in FIG. 1b, here as an example with origin on the workpiece spindle axis A. In the embodiment example shown here, the workpiece carrier 20 is a workpiece slide that can be moved in the Y_{M} direction. The machine tool 2 shown here also has a sensor positioning device 25, which is arranged on a tool carrier 24, wherein a tool spindle 241 for rotationally driving a machining tool is arranged on the tool carrier 24. The sensor positioning device 25 is movable together with the tool carrier 24 in the X_{M} direction and in the Z_{M} direction and has a sensor positioning arm 251 which is linearly displaceable in a Y_{M}/Z_{M} plane and in which the meshing sensor 1 is arranged. Here, the meshing sensor 1 is aligned antiparallel to the Y_{M} direction. In FIGS. 1a and 1b, different embodiments of a calibration piece 10 are arranged in the same machine tool 2 for illustrative purposes. In practice, however, it is usually sufficient if the machine tool has only one of these embodiments of the calibration piece 10. As can be seen from FIG. 1b, the various embodiments are arranged in the machine tool in such a way that the meshing sensor 1 can be moved along the calibration piece 10 by means of the sensor positioning device 25 in order to determine its response behavior, whereby the meshing sensor always remains aligned antiparallel to the Y_{M} direction during the movements 1 here. Furthermore, in order to achieve a movement of the calibration piece 10 relative to the meshing sensor 1 in the Y_{M} direction, the workpiece carrier 20 can also be moved in the machine tool 2 shown here. Also shown is a scanning means 30 arranged on the tool carrier 24, which can be used to determine the calibration point C_{M} of the calibration piece 10 in the coordinate system K_{M} of the machine tool 2.

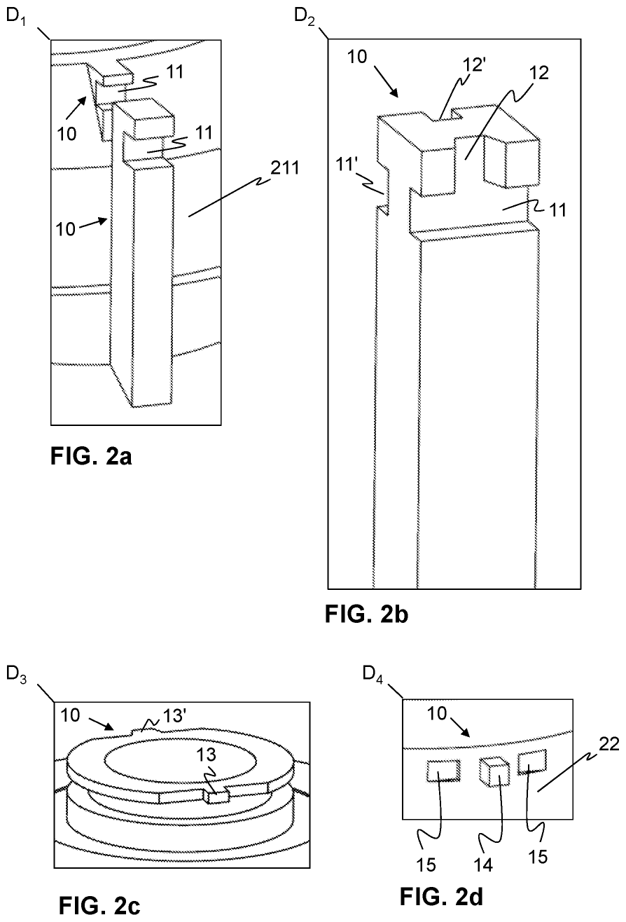

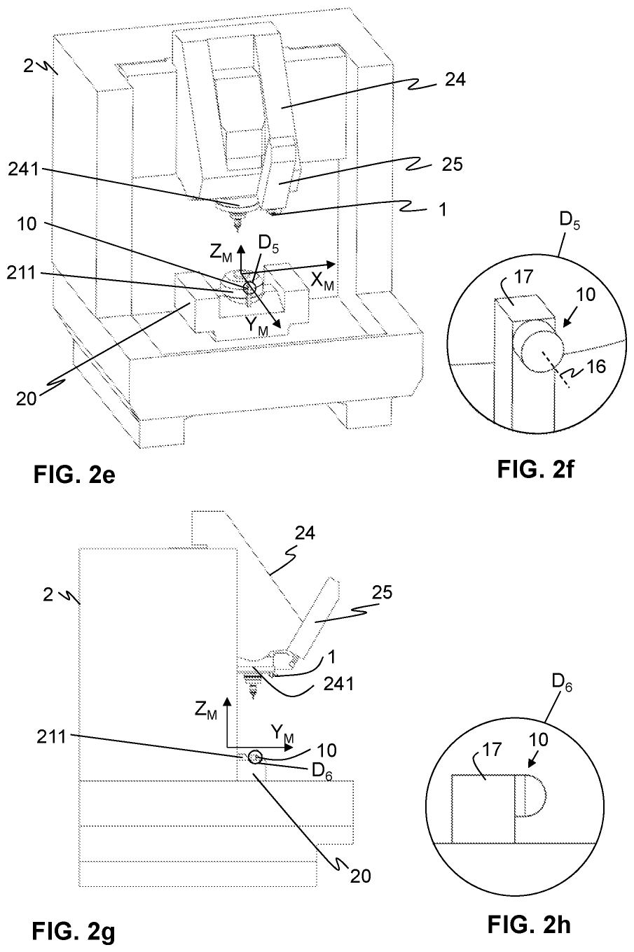

FIGS. 2a-d show enlarged versions of the calibration piece 10 shown in FIGS. 1a and 1b.

In the image section D₁ of FIG. 1b shown in FIG. 2a, two embodiments of the calibration piece 10 can be seen. Both embodiments are arranged on the workpiece spindle housing 211. The first embodiment shown in the image detail in a front plane has a cuboid base body, wherein the base body has a first groove 11 with a rectangular cross-section, wherein the first groove 11 extends in the X_{M} direction. The second embodiment shown in a rear plane in the image detail protrudes from a beveled surface of the workpiece spindle housing 211 and also has a first groove 11 extending in the X_{M} direction with a rectangular cross-section. As can be seen in FIG. 1b, both of these embodiments are arranged on the workpiece spindle housing such that the groove 11 extends in a tangential direction with respect to the workpiece spindle 21. In order to determine the response behavior of the meshing sensor 1, the meshing sensor 1 on a side of the calibration piece 10 having the groove 11 can be moved in the tangential direction along the groove 11 and/or in the Z_{M} direction (which corresponds to an axial direction with respect to the workpiece spindle 21) and/or in the Y_{M} direction (which corresponds to a radial direction with respect to the workpiece spindle 21).

In the image section D₂ of FIG. 1b shown in FIG. 2b, a third embodiment of the calibration piece 10 can be seen, which is arranged on the workpiece carrier 20. The third embodiment shown in FIG. 2b has a cuboid base body, the base body having a first groove 11 with a rectangular cross section. The base body of this third embodiment of the calibration piece further comprises a second groove 12, which extends perpendicularly to the first groove 11 and opens into the first groove 11, said second groove 12 having a trapezoidal cross-section. On a side of the calibration piece 10 opposite the side having the groove 11, the calibration piece 10 has a further groove 11′ which runs parallel to the groove 11. Perpendicular to groove 11′ runs a further groove 12′ with a rectangular cross-section, which opens into groove 11′. As can be seen from FIG. 1b, this third embodiment of the calibration piece 10 is arranged on the workpiece slide in such a way that the second groove 12 runs parallel to the workpiece spindle axis A, thus imitating the shape and orientation of a tooth gap in a workpiece to be machined. To determine the response behaviour of the meshing sensor 1, the meshing sensor 1 can be moved on a side of the calibration piece 10 having the grooves 11 and 12 in a tangential direction along the groove 11 and/or in a Z_{M} direction (which corresponds to an axial direction with respect to the workpiece spindle 21) and/or in a Y_{M} direction (which corresponds to a radial direction with respect to the workpiece spindle 21). As indicated in FIG. 1b, this embodiment of the calibration piece can also be attached to the workpiece carrier (20) rotated by 180°, whereby the groove 12′ with the rectangular cross-section is then oriented towards the meshing sensor 1 during the calibration method.

In the image section D₃ of FIG. 1b shown in FIG. 2c, a fourth embodiment of the calibration piece 10 can be seen, which is detachably arranged in the clamping means 22. This fourth embodiment of the calibration piece 10 is disk-shaped and has an outer profile with calibration teeth 13,13′. In this embodiment, two calibration teeth 13,13′ are located radially opposite each other, the first calibration tooth 13 having a rectangular shape, while the second calibration tooth 13 has a trapezoidal shape. The calibration teeth 13,13′ are aligned in the Y_{M} direction. To determine the response behavior of the meshing sensor 1, it can be moved in a tangential direction with respect to the workpiece spindle (X_{M}-direction), whereby the meshing sensor 1 aligned antiparallel to the Y_{M}-direction can scan one of the two calibration teeth (here the one with the rectangular shape, 13) without contact. If scanning of the calibration tooth 13′ (trapezoidal shape) is preferred, the calibration piece can be arranged rotated by 180°.

In the image section D₄ of FIG. 1b shown in FIG. 2d, a fifth embodiment of the calibration piece 10 can be seen, which is arranged on the clamping means 22. The fifth embodiment of the calibration piece 10 has a cuboid projection 14 which extends radially from a surface of the clamping means 21, the cuboid projection 14 being flanked by two orientation areas projecting into the surface of the clamping means. In the embodiment example shown here, the projection points in the Y_{M} direction and the flanking orientation areas 15 are arranged on both sides of the projection 14 with respect to the tangential direction in such a way that the orientation areas 15 lie in the X_{M}/Z_{M} plane.

FIG. 2e shows a perspective view of a machine tool 2 with a sixth embodiment of the calibration piece, which is arranged on the workpiece spindle housing 211. As can be seen in the enlargement of the image section D₅ in FIG. 2f, this sixth embodiment of the calibration piece has a cylindrical base body, which is arranged on a cuboid carrier 17. The cylindrical base body has a cylinder axis 16, which runs parallel to the Y_{M} axis in this case.

FIG. 2g shows a side view of a machine tool 2 with a seventh embodiment of the calibration piece, which is arranged on the workpiece spindle housing 211. As can be seen in the enlargement of the image section D₆ in FIG. 2h, this seventh embodiment of the calibration piece has a dome-shaped base body which is arranged on a cuboid carrier 17, the dome-shaped base body pointing in the Y_{M} direction.

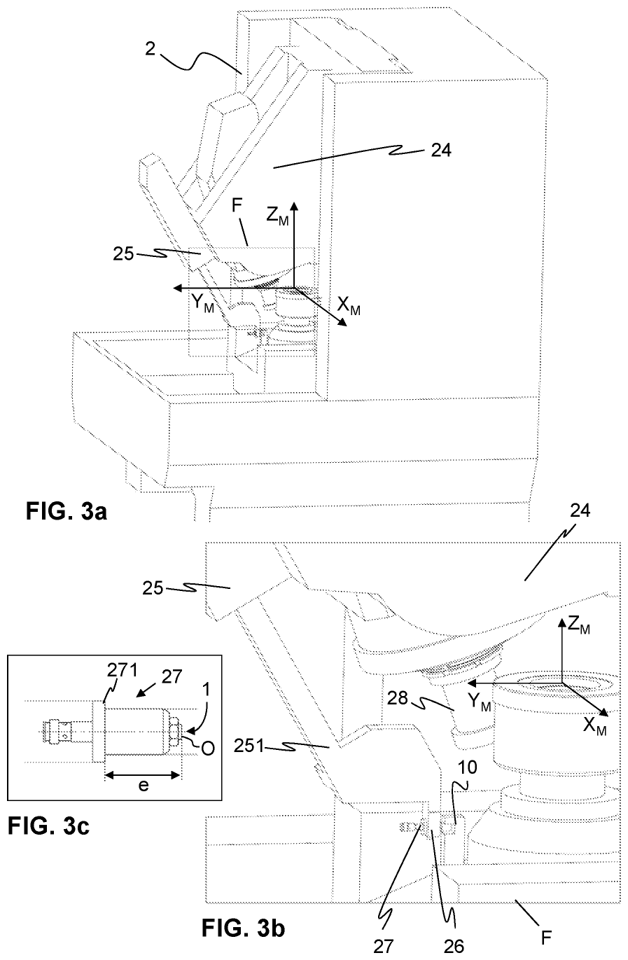

FIGS. 3a and 3b show a preferred arrangement of the calibration piece 10, which corresponds to the first embodiment in FIG. 2a, in the machine tool 2, with FIG. 3b showing an enlargement of the section F framed in FIG. 3a. The sensor positioning arm 251 has a sensor holder 26, which forms a mechanical receptacle for a sensor carrier 27. As can be seen in FIG. 3c, the sensor carrier 27 has a stop element 271 which serves as a positioning aid for mounting the sensor carrier 27 in the sensor holder 26. The meshing sensor 1 has a meshing sensor surface O and is mounted in the sensor carrier 27 in such a way that the meshing sensor surface O is at a defined distance e from the stop element 271. Such a sensor carrier 27 forms a uniform interface to the sensor holder 26 for meshing sensors 1 of different sizes. If the meshing sensor 1 has to be replaced, it can be removed from the sensor holder 26 together with the sensor carrier 27. A new meshing sensor is then installed in the sensor carrier 27 in such a way that its meshing sensor surface is also at the same defined distance e from the stop element 271, which can be checked by a suitable measuring means before the sensor carrier 27 is reinstalled in the sensor holder 26. As can be seen in FIGS. 3a and 3b, the sensor positioning device 25 with the meshing sensor 1 in the sensor holder 26 can be moved without collision to the calibration piece 10 despite a machining tool 28 arranged on the tool holder 24 in order to scan the calibration piece 10 along the directions X_{M}, Y_{M} and Z_{M} without contact, with the meshing sensor 1 aligned antiparallel to the Y_{M} direction.

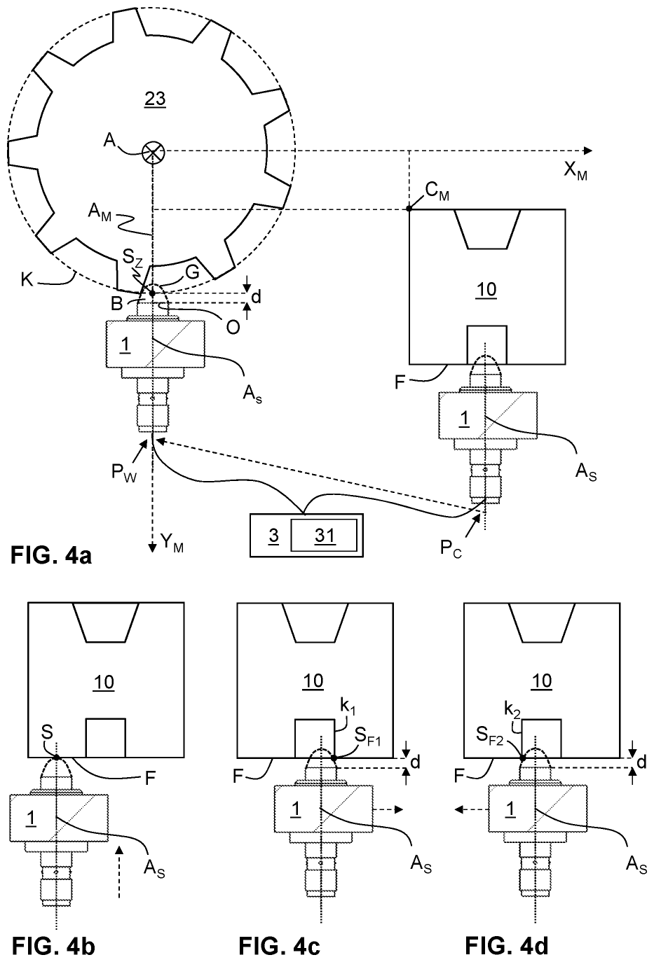

FIGS. 4a-4d illustrate in a schematic (not to scale) manner a method for calibrating a contactless meshing sensor 1 that outputs switching signals in accordance with the present invention. The meshing sensor shown in this embodiment has a switching region B which extends from a meshing sensor surface O to a switching interface G shown here as a dashed line and defines a fictitious sensor axis A_{S}. If material enters the switching region B, the switching signal output by the meshing sensor 1 changes. In order to be able to reliably determine the phase position of the teeth of a pre-toothed workpiece 23 with tip circle K, the workpiece measuring position P_{W} is to be calculated in such a way that a response behavior of the meshing sensor 1 that is as symmetrical as possible is achieved. Such a symmetrical response behavior is achieved if the fictitious sensor axis A_{S} coincides with a predefined measuring axis A_{M} (here parallel to the Y_{M} direction at a predefined height in the Z_{M} direction), and if the meshing sensor surface O is spaced apart from the tip circle K by a predefined measuring distance d such that the tip circle K crosses the switching region B (see FIG. 4a).

According to the present invention, the fictitious sensor axis A_{S} of the meshing sensor 1 is determined on the basis of the calibration piece 10, the calibration piece 10 having a known geometry and being located at a known calibration point C_{M} in the coordinate system K_{M} of the workpiece carrier. For this purpose, the meshing sensor 1 is brought into the vicinity of the calibration piece.

Possible steps of a calibration procedure are shown in FIGS. 4b-4d:

In this example, a peak switching point S of the switching region is first determined in a first step (FIG. 4b) by approaching an end face F of the calibration piece 10, the end face here lying in the X_{M}-Z_{M} plane. If a theoretical position of the meshing sensor 1 in the coordinate system K_{M} of the workpiece carrier is already known, for example because it has been determined by a geometric measurement in the machine and stored in the sensor controller, the determination of the peak switching point S can also be omitted, since the known theoretical position of the meshing sensor 1 allows the latter to be moved directly to a predefined calibration position Pc. However, the meshing sensor can also be in an instantaneous position that deviates from the theoretical position; for example, if the machine is in a different temperature state than during the determination of the theoretical position. Likewise, the instantaneous position of the meshing sensor can deviate from the theoretical position if there is an installation error; for example, if the meshing sensor surface O does not have the intended distance e from the stop element shown in FIG. 3c, or if the stop element 271 of the sensor carrier 27 has not been mounted flush against the sensor holder 26. By determining the peak switching point S in the coordinate system K_{M} of the workpiece carrier, such installation errors can be detected.

In a second step (FIG. 4c and FIG. 4d), the meshing sensor 1 is moved antiparallel to the Y_{M} direction closer to the calibration piece 10, ideally in such a way that the meshing sensor surface O is spaced apart from the end face F by the predefined measuring distance d, which should then also occur between the meshing sensor surface O and a tip circle K of the workpiece 23 when the meshing sensor 1 (as shown in FIG. 4a) is in the workpiece measuring position P_{W}.

In a third step, flank switching points are determined which are located on the switching interface G of the switching region B of the meshing sensor in the X_{M} and Z_{M} directions. In a simple embodiment of the calibration method, this third step is performed at a single measuring distance d in the Y_{M} direction, whereby two flank switching points each are preferably determined in the X_{M} direction and in the Z_{M} direction. FIG. 4c shows as an example how the meshing sensor is moved past a first flank k₁ of the calibration piece parallel to the X_{M} direction to determine a first flank switching point S_{F1}, while FIG. 4d shows how the meshing sensor is moved past a second flank k₂ of the calibration piece anti-parallel to the X_{M} direction to determine a second flank switching point S_{F2}. By moving the meshing sensor 1 along the Z_{M} direction, two further flank switching points can be determined in the same way. The determined flank switching points are stored in a memory 31 of the sensor controller 3. A theoretical central point S_{Z} of the switching region B can then be determined from the stored flank switching points. A fictitious axis A_{S} is placed through this theoretical central point S_{Z}, whereby this fictitious axis A_{S} is normal to the X_{M}-/Z_{M}-plane.

For the measurement on the workpiece, the meshing sensor is then brought into the workpiece measuring position P_{W} in such a way that this fictitious sensor axis A_{S} comes to lie on the desired measuring axis A_{M}, and as shown in FIG. 4a ideally in such a way that the central point S_{Z} comes to lie on a point of intersection of the measuring axis A_{M} with the tip circle K, thus achieving a response behavior of the meshing sensor 1 that is as symmetrical as possible.

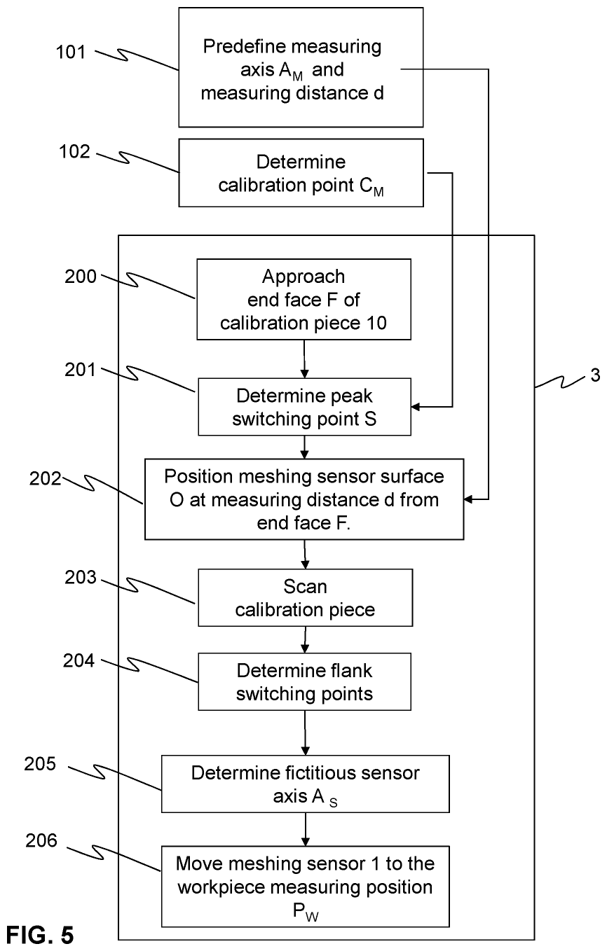

FIG. 5 shows the above-described example of a calibration method of a meshing sensor 1 in a machine tool 2 for machining pre-toothed workpieces, for the execution of which the machine tool is designed according to one embodiment of the present invention. First, a measuring axis A_{M} and a measuring distance d are defined 101 in the coordinate system K_{M} of the tool carrier, and the calibration point C_{M} is determined 102 at which the calibration piece 10 is arranged. Subsequently, the meshing sensor 1 is moved toward an end face F of the calibration piece 200 and a peak switching point S of the switching region B is determined 201. Then the meshing sensor 1 is positioned in such a way that the meshing sensor surface O is spaced from the end face of the calibration piece 10 by the measuring distance d 202. Now the meshing sensor 1 is moved along the calibration piece 10 to scan it without contact 203. Meanwhile, the meshing sensor 1 outputs switching signals from which flank switching points are determined 204. A fictitious sensor axis A_{S} is then determined from these flank switching points 205. In a final step 206, the meshing sensor 1 is brought into a workpiece measuring position P_{W} calculated by the sensor controller 3, in which the determined fictitious sensor axis A_{S} coincides with the measuring axis A_{M}.

### LIST OF REFERENCE SIGNS

| | | | |
|---|---|---|---|
| 1 | meshing sensor | 271 | stop element |
| 2 | machine tool | 28 | machining tool |
| 3 | sensor controller | 30 | scanning means |
| 10 | calibration piece | 31 | memory |
| 11, 11′ | first groove | K_{M} | coordinate system of the |
| 12, 12′ | second groove | | workpiece carrier |
| 13, 13′ | calibration tooth | C_{M} | calibration point |
| 14 | projection | P_{W} | workpiece measuring |
| | | | position |
| 15 | orientation area | P_{C} | calibration position |
| 16 | cylinder axis | A | workpiece spindle axis |
| 17 | cuboid carrier | A_{M} | measuring axis |
| 20 | workpiece carrier | A_{S} | fictitious sensor axis |
| 21 | workpiece spindle | B | switching region |
| 211 | workpiece spindle housing | d | measuring distance |
| 212 | workpiece spindle shaft | F | end face |
| 22 | clamping means | O | meshing sensor surface |
| 23 | workpiece | G | switching interface |
| 24 | tool carrier | S | peak switching point |
| 241 | tool spindle | S_{Z} | central point |
| 25 | sensor positioning device | S_{F1}, | flank switching points |
| | | S_{F2} | |
| 251 | sensor positioning arm | k₁, | flanks |
| | | k₂ | |
| 26 | sensor holder | | |
| 27 | sensor carrier | | |

1. A machine tool for machining pre-toothed workpieces, comprising:
a workpiece carrier;
workpiece spindle arranged on the workpiece carrier and defining a workpiece spindle axis, the workpiece spindle having a workpiece spindle housing and a workpiece spindle shaft rotatable in the workpiece spindle housing about the workpiece spindle axis for rotationally driving a pre-toothed workpiece to be machined;
a meshing sensor configured to detect a phase position of teeth of the workpiece when the workpiece rotates about the workpiece spindle axis,
wherein the machine tool further comprises:
a calibration piece located at a defined calibration point relative to the workpiece spindle; and
a sensor controller configured to carry out the following method:
moving the meshing sensor relative to the workpiece spindle to a calibration position in which the meshing sensor is located at the calibration piece;
determining a response behavior of the meshing sensor by the sensor controller moving the meshing sensor relative to the calibration piece while receiving sensor calibration signals of the meshing sensor, and
moving the meshing sensor to a workpiece measuring position in which the meshing sensor is located at the workpiece, wherein the workpiece measuring position depends on the determined response behavior.

2. The machine tool according to claim 1, wherein moving the meshing sensor relative to the calibration piece includes at least one of: movements in an axial direction, in a radial direction, or in a tangential direction with respect to the workpiece spindle.

3. The machine tool according to claim 1, wherein the calibration piece is arranged on the workpiece carrier.

4. The machine tool according to claim 1, wherein the calibration piece is arranged on a stationary part of the workpiece spindle.

5. The machine tool according to claim 1, wherein the calibration piece is arranged on a rotatable part of the workpiece spindle.

6. The machine tool according to claim 1,
wherein the workpiece spindle has a clamping means for clamping a workpiece on the workpiece spindle shaft, and wherein the calibration piece is arranged on the clamping means.

7. The machine tool according to claim 6, wherein the calibration piece is configured such that it can be detachably fastened to the clamping means.

8. The machine tool according to claim 7, wherein the calibration piece is configured such that it is attachable to and removable from the clamping means by an automatic workpiece loading device.

9. The machine tool according to claim 1, wherein the calibration piece has a substantially cuboid base body.

10. The machine tool according to claim 9, wherein the base body of the calibration piece has a first groove.

11. The machine tool according to claim 10, wherein the calibration piece is arranged in the machine tool such that the first groove in the base body of the calibration piece runs perpendicular to the workpiece spindle axis.

12. The machine tool according to claim 10, wherein the base body of the calibration piece has a second groove, which runs at an angle to the first groove and opens into the first groove.

13. The machine tool according to claim 1, wherein the calibration piece has a cuboid projection extending radially from a surface of a portion of the workpiece spindle,
wherein the cuboid projection is flanked by two orientation areas, and wherein the flanking orientation areas are arranged on both sides of the projection with respect to a tangential direction.

14. The machine tool according to claim 1, wherein the calibration piece has a cylindrical base body.

15. The machine tool according to claim 1, wherein the calibration piece has a spherical base body or a dome-shaped base body.

16. The machine tool according to claim 1, wherein the calibration piece is disc-shaped and has an outer profile with at least one tooth structure.

17. The machine tool according to claim 16, wherein the calibration piece is a workpiece to be machined.

18. The machine tool according to claim 1, wherein the machine tool comprises a tactile sensor,
wherein the tactile sensor is adapted to measure the calibration piece to obtain a defined calibration point.

19. The machine tool according to claim 1, wherein the machine tool has a tool carrier on which a tool spindle for rotationally driving a machining tool is arranged, and wherein the meshing sensor is arranged on the tool carrier.

20. The machine tool according to claim 1, wherein the sensor controller is configured to cause the movement of the meshing sensor relative to the workpiece spindle by movements of the tool carrier relative to the workpiece spindle.

21. The machine tool according to claim 1, wherein the machine tool comprises a sensor positioning device for positioning the meshing sensor, which is arranged on the tool carrier and is movable together with the tool carrier relative to the workpiece spindle, wherein the sensor positioning device is configured to move the meshing sensor relative to the tool carrier, and wherein the sensor controller is configured to effect the movement of the meshing sensor relative to the workpiece spindle by at least one of: movements of the tool carrier relative to the workpiece spindle or by movements of the sensor positioning device relative to the tool carrier.

22. The machine tool according to claim 21, wherein the sensor positioning device comprises a sensor positioning arm which is movable relative to the tool carrier.

23. The machine tool according to claim 21,
wherein the sensor positioning device comprises a sensor holder for receiving a sensor carrier,
wherein the sensor carrier comprises a stop element,
wherein the meshing sensor has a meshing sensor surface, and wherein the meshing sensor is mounted in the sensor carrier such, that the meshing sensor surface is at a defined distance from the stop element.

24. The machine tool according to claim 1,
wherein the meshing sensor is an inductive meshing sensor, and
wherein at least one of: the calibration piece consists of an electrically conductive material or has an electrically conductive surface.

25. The machine tool according to claim 1,
wherein the meshing sensor is a capacitive meshing sensor, and
wherein at least one of: the calibration piece consists of a dielectric material or has a surface made of a dielectric material.

26. The machine tool according to claim 1,
wherein the meshing sensor is configured to output a switching signal,
wherein the meshing sensor has a sensor-specific switching region, and
wherein the sensor-specific switching region defines a fictitious sensor axis.

27. The machine tool according to claim 26,
wherein the calibration point of the calibration piece in a coordinate system of the workpiece carrier is known,
wherein the sensor controller is configured to determine the fictitious sensor axis by determining the response behavior of the meshing sensor on the calibration piece,
wherein the sensor controller is further configured to calculate the workpiece measuring position from the known calibration point of the calibration piece, a predefined measuring axis and the determined fictitious sensor axis in such a way that the determined fictitious sensor axis coincides with the predefined measuring axis when the meshing sensor is in the calculated workpiece measuring position.

28. The machine tool according to claim 26,
wherein the sensor controller for determining the response behavior of the meshing sensor is configured to determine a peak switching point of the switching region in a coordinate system of the workpiece carrier by moving the meshing sensor in the normal direction towards an end face of the calibration piece.

29. The machine tool according to claim 27, wherein the calibration point of the calibration piece and the predefined measuring axis are stored in a memory of the sensor controller and the method is carried out automatically.

30. The machine tool according to claim 4, wherein the calibration piece is arranged on the workpiece spindle housing.

31. The machine tool according to claim 10, wherein the first groove has a rectangular or trapezoidal cross-section.

32. The machine tool according to claim 12, wherein the second groove has at least one of: a rectangular or trapezoidal cross-section or runs perpendicular to the first groove.

33. The machine tool according to claim 16, wherein the tooth structure is a calibration tooth.

34. The machine tool according to claim 22, wherein the sensor positioning arm is linearly displaceable relative to the tool carrier.

35. The machine tool according to claim 24, wherein the calibration piece consists of steel or cast steel or aluminum.
